(19) United States
(12) Patent Application Publication
(10) Pub. No.: US 2012/0143701 A1
(43) Pub. Date: Jun. 7, 2012

(54) RE-PUBLISHING CONTENT IN AN ACTIVITY STREAM

(75) Inventors: Davi Reis, Belo Horizonte (BR); Christian Oestlien, New York, NY (US); Eider Silva de Oliveira, Belo Horizonte (BR); Marcus A. Leal, Belo Horizonte (BR); Amy Wu, Sunnyvale, CA (US); Brandon M. Pearcy, San Francisco, CA (US); Yi Zhang, Sunnyvale, CA (US); Jennifer W. Lin, San Jose, CA (US)

(73) Assignee: GOOGLE INC., Mountain View, CA (US)

(21) Appl. No.: 13/308,096

(22) Filed: Nov. 30, 2011

Related U.S. Application Data
(60) Provisional application No. 61/418,847, filed on Dec. 1, 2010.

(51) Int. Cl. G06Q 30/02

(52) U.S. Cl. 705/14.73

(57) ABSTRACT

Methods, systems, and apparatus, including computer programs encoded on a computer-readable storage medium, for providing a method for re-publishing content that is provided by a content publisher to a user. A method includes providing an advertisement for display to a user in a slot, the advertisement including a first annotation providing information for or about re-publishing the advertisement; receiving a request to re-publish the advertisement to one or more individuals or groups associated with the user in a social context; and providing the advertisement as part of an activity stream for a social application, including presenting the advertisement in the activity stream for the user.

### CROSS-REFERENCE TO RELATED APPLICATION

This application claims priority to U.S. Provisional Application No. 61/418,847, filed on Dec. 1, 2010. The disclosure of the prior application is considered part of and is incorporated by reference in the disclosure of this application

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for advertisements to be provided with the resources. For example, a web page can include advertisement slots in which advertisements can be presented. These advertisements slots can be defined in the web page or defined for presentation with a web page, for example, in a pop-up window.

Advertisement slots can be allocated to advertisers through an auction. For example, advertisers can provide bids specifying amounts that the advertisers are respectively willing to pay for presentation of their advertisements (“ads”). In turn, an auction can be performed and the advertisement slots can be allocated to advertisers according, among other things, to their bids and/or the relevance of the advertisement to content presented on a page hosting the slot or a request that is received for the advertisement.

### SUMMARY

In general, one innovative aspect of the subject matter described in this specification can be implemented in methods that include a method for re-publishing content that is provided by a content publisher to a user. The method comprises: providing an advertisement for display to a user in a slot, the advertisement including a first annotation providing information for or about re-publishing the advertisement; receiving a request to re-publish the advertisement to one or more individuals or groups associated with the user in a social context; and providing the advertisement as part of an activity stream for a social application, including presenting the advertisement in the activity stream for the user.

These and other implementations can each optionally include one or more of the following features. Providing the advertisement as part of the activity stream can include determining information to be included in a second annotation that is provided along with the advertisement when displayed in the activity stream including determining message content to be included in the second annotation. The message content can include an indicator of a number of users in a user's group that endorsed the advertisement. Example endorsements can include, for example, support, back, admire, like, approve, etc. The user's group can be a social circle or a social graph. For example, a social graph can include the set of online relationships between users, such as provided by one or more social networking web sites, including explicitly-defined relationships and relationships implied by social connections with other online users, where the relationships form a social graph. The message content can include an indicator of which members of a user's group endorsed the advertisement. Providing the advertisement can include providing either the first or the second annotation as an overlay to the advertisement. The first annotation can include an information portion and a control, the control for enabling the user to re-publish the advertisement. The control can enable a user to re-publish the advertisement to one or more members of the user's groups. The groups can be selected from the groups comprising a social circle, family, friends, work groups, or other particularly identified groups. The control can enable the user to re-publish the advertisement to others that are not members of a user's groups. The control can enable a user to re-publish the advertisement along with a message. The message can be provided by the user. The message can indicate that the advertisement has been re-published by the user. The message can indicate that the user and a number of other users have re-published the advertisement. The other users can be within a predetermined proximity of the user. The message can include two portions, a first portion that can indicate who has re-published the advertisement and a second portion with specific comments by users that re-published the advertisement. The method can further comprise receiving a comment from the user to be published in the second portion. The method can further comprise providing the annotation along with the comment when re-publishing the advertisement. The method can further comprise receiving a request to re-publish the advertisement to one or more other users and re-publishing the advertisement to the one or more other users including providing a second different annotation along with the re-published advertisement. Re-publishing the advertisement can include determining a message for inclusion in the second different annotation. The message can include an indication that the user has re-published the advertisement and including any comment provided by the user. Providing the advertisement as part of an activity stream can further include providing visibility of the advertisement, within the social application, to the one or more individuals or groups associated with the user to whom the user re-publishes the advertisement, and can further include providing interaction with the advertisement by the user and the one or more individuals or groups associated with the user. After receiving a request to re-publish the advertisement filtering the request can be in accordance with one or more criteria. Filtering the request can include evaluating one or more characteristics associated with the user to determine if the request should be granted. Filtering the request can include evaluating one or more characteristics of a user to whom the advertisement was requested to be re-published to in order to determine if the request should be granted. Filtering the request can include evaluating one or more criteria for the advertiser associated with the advertisement that is proposed to be re-published in order to determine if the request should be granted. Filtering the request can include evaluating historical re-publishing statistics in order to determine if the request should be granted. The historical re-publishing statistics can include statistics associated with the user. The historical re-publishing statistics can include statistics associated with the advertisement. The request can include re-publishing a limited number of requests in a time period. The limited number can be determined on a per user basis. The limited number can be determined based on characteristics of the user or followers of a user's activity stream.

In general, another innovative aspect of the subject matter described in this specification can be implemented in methods that include a method for re-publishing content that is provided by a content publisher to a user. The method comprises: providing an advertisement for display to a user in a slot, the advertisement including a first annotation providing information for or about re-publishing the advertisement; receiving a request from the user to re-publish the advertisement to one or more individuals or groups designated by the user; and providing the advertisement as part of an update posting for the user in a social context, where the social context is related to a social application executing on one or more servers, the social application including a presence associated with the user for providing updates about the user to one or more subscribers.

These and other implementations can each optionally include one or more of the following features. The social application can be, by way of example, Orkut, MySpace, Buzz. The update posting can include update content for or about the user. After receiving a request to re-publish the advertisement filtering the request can be in accordance with one or more criteria. Filtering the request can include evaluating one or more characteristics associated with the user to determine if the request should be granted. Filtering the request can include evaluating one or more characteristics of a user to whom the advertisement was requested to be re-published to in order to determine if the request should be granted. Filtering the request can include evaluating one or more criteria for the advertiser associated with the advertisement that is proposed to be re-published in order to determine if the request should be granted. Filtering the request can include evaluating historical re-publishing statistics in order to determine if the request should be granted. The historical re-publishing statistics can include statistics associated with the user. The historical re-publishing statistics can include statistics associated with the advertisement. Filtering the request can include re-publishing a limited number of requests in a time period. The limited number can be determined on a per user basis. The limited number can be determined based on characteristics of the user or followers of a user's activity stream. The details of one or more implementations of the subject matter described in this specification are set forth in the accompanying drawings and the description below. Other features, aspects, and advantages of the subject matter will become apparent from the description, the drawings, and the claims.

Particular implementations may realize none, one or more of the following advantages. For example, a user can re-publish content, such as an ad, to the user's activity stream. In another example, the user can designate which other users can view the content. Re-published content can be made available to other users is the user's group (e.g., social network). The other users can see the ad, displayed in the activity stream, and can interact with ad (e.g., video, animation, etc.).

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for re-publishing ads in an activity stream.

FIG. 2 shows an example user interface that includes content with a control for re-publishing the content.

FIG. 3 shows an example details popup for providing detailed information for re-publishing an ad.

FIG. 4 shows an example visibility change popup for changing visibility settings for re-publishing an ad.

FIG. 5 shows an example groups selection list for displaying selectable visibility groups.

FIG. 6 shows an example add comment box for commenting on an ad.

FIG. 7A shows an example display ad that is re-published in an activity stream.

FIG. 7B shows an example text ad that is re-published in the activity stream.

FIG. 7C shows an example multimedia ad that is re-published in the activity stream.

FIG. 7D shows an example re-published display ad that is expanded.

FIG. 7E shows an example multimedia ad that is re-published, expanded and being played in the activity stream.

FIG. 7F shows an example social context entry that appears on a third-party website.

FIG. 8 is a flowchart of an example process for re-publishing content that is provided by a content publisher to a user's activity stream.

FIG. 9 is block diagram of an example computer system that can be used to implement the methods, systems and processes described in this disclosure.

Like reference numbers and designations in the various drawings indicate like elements.

### DETAILED DESCRIPTION

When a user requests on-line content (e.g., a web page or another online resource), content requests can be initiated to request content from a content publisher for presentation on a user device. For example, content publishers can include publishers of web sites or search engines that are publishing search results responsive to a query. One or more additional content items (e.g., ads) can be provided along with the requested content. As a result, the presented content can be, for example, text, images, audio, video, advertisements (or ads) or other content selected for presentation to the user. In response to each content request received, content can be served, including one or more ads. In some implementations, some ads can include a social component or context.

For example, an ad that is served can include a tool for propagating, or re-publishing the ad, such as in an activity stream. As a result, users can share ads with others, including friends and family. For example, an ad with associated comments can be presented as an update to a social application activity stream of the user, to activity streams of friends and family, and/or activity streams of one or more groups associated with the user. By re-publishing an ad, a user can make his preferences known, including providing comments for specific ads, and the comments can be handled in a structured way. By providing the ability for users to re-publish and comment upon ads within a social context, ads can be more interesting to users and their social contacts. As a result, more user attention can be captured by the ads, which can result in higher click-through-rates and overall ad effectiveness. Another use and benefit of re-publishing ads is the ability to capture user feedback. Advertisers can capture information (e.g., ad-re-publishing statistics, etc.) for ads in order to gauge the quality of their ads, the effectiveness of ad campaigns, and the popularity of certain product brands that are featured in ads.

In general, activity streams, as provided by social networking web sites and applications, allow a user to publish user updates and make the updates accessible or viewable by designates. For example, a user can publish messages, photos, or other content to his activity stream, and share the content with individuals, family, friends, or other groups. Alternatively, the user's publication of content can be to a presence associated with the user in a social environment. In another example, the publication can be directly to a subscriber to the updates. In some implementations, the publication can be to an area that is designated for providing updated content for the user (e.g., a wall or social profile page). Other mechanisms are possible for providing the publication medium. Activity streams can include, for example, content that has been authored and/or posted by the user or anyone in the user's social graph. Activity streams can also include, for example, content that has been endorsed and/or shared by the user or anyone in the user's social graph.

For example, an ad that is re-published to an activity stream can be further shared or re-published by a user's friends. As a result, the ad may be re-published to the friends of his friends, and thus propagated along one or more social circles as the ads are shared. The terms circles and social circles when discussed in this document refer to members of the user's social graph. An ad that is re-published to an activity stream can preserve the original meta-data that is associated with the ad, such as the display and destination URLs. As a result, users can interact fully with a re-published ad, including navigating to one or more web pages associated with the ad, just as if they are seeing the ad for the first time (e.g., not yet re-published).

In some implementations, a widget (e.g., a graphical user interface control) can be overlaid on an ad creative that is displayed to Internet users, such as on a third-party web site. The widget can include a button or other control that allows the user to re-publish and comment on a given ad.

Although the examples in this disclosure focus primarily on re-publishing advertisements, re-publishing can occur on any types of content, including websites or any other resource provided by a content provider. Furthermore, re-publishing can occur for content ads on third-party websites.

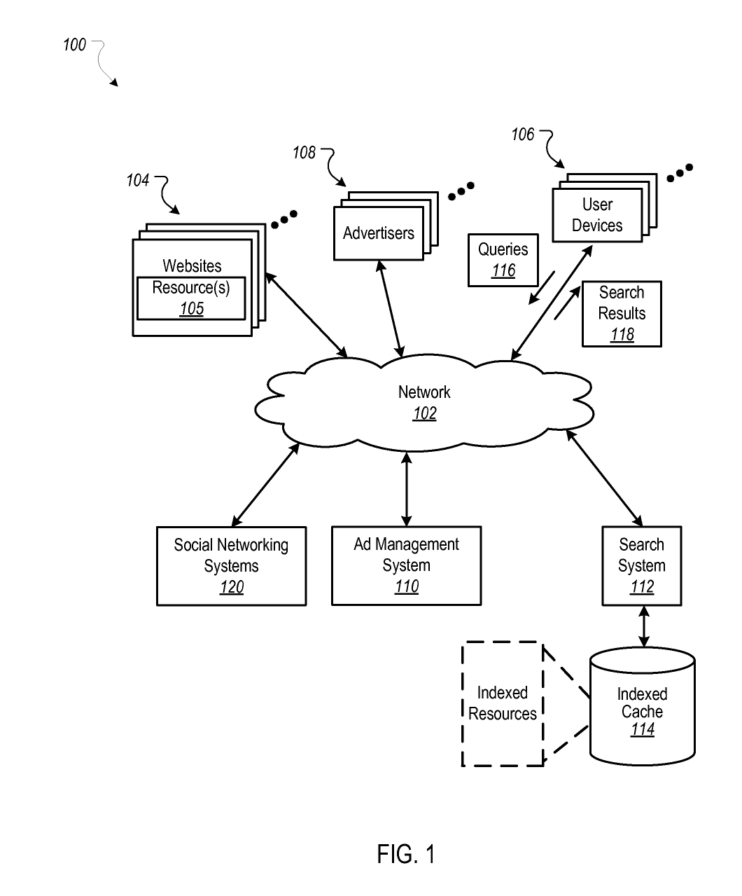

FIG. 1 is a block diagram of an example environment 100 for re-publishing ads in an activity stream. The example environment 100 includes an ad management system 110 that manages advertising services and one or more social networking systems 120 that allow users to interact with other users within a social framework. The example environment 100 includes a network 102, such as a local area network (LAN), a wide area network (WAN), the Internet, or a combination thereof. The network 102 connects websites 104, user devices 106, advertisers 108, the ad management system 110, and social networking systems 120. The example environment 100 may include many thousands of websites 104, user devices 106, and advertisers 108.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images and sounds, that may include embedded information (such as meta-information in hyperlinks) and/or embedded instructions (such as JavaScript scripts).

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page, in which advertisements can be presented. These specified portions of the resource or user display are referred to as advertisement slots.

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. An example search result 118 can include a web page title, a snippet of text or a portion of an image extracted from the web page, and the URL of the web page. Search results pages can also include one or more advertisement slots in which advertisements can be presented.

When a resource 105 or search results 118 are requested by a user device 106, the ad management system 110 receives a request for advertisements to be provided with the resource 105 or search results 118. The request for advertisements can include characteristics of the advertisement slots that are defined for the requested resource or search results page, and can be provided to the ad management system 110.

For example, a reference (e.g., URL) to the resource for which the advertisement slot is defined, a size of the advertisement slot, and/or media types that are available for presentation in the advertisement slot can be provided to the ad management system 110. Similarly, keywords associated with a requested resource (“resource keywords”) or a search query 116 for which search results are requested can also be provided to the ad management system 110 to facilitate identification of advertisements that are relevant to the resource or search query 116.

Based at least in part on data included in the request for advertisements, the ad management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries 116. In some implementations, advertisements having targeting keywords that match the resource keywords or the search query 116 are selected as eligible advertisements by the ad management system 110.

A targeting keyword can match a resource keyword or a search query 116 by having the same textual content (“text”) as the resource keyword or search query 116. For example, an advertisement associated with the targeting keyword “beaches” can be an eligible advertisement for an advertisement request including the resource keyword “beaches.” Similarly, the advertisement can be selected as an eligible advertisement for an advertisement request including the search query “beaches.”

The ad management system 110 can select from the eligible advertisements that are to be provided for presentation in advertisement slots of a resource or search results page based on results of an auction. For example, the ad management system 110 can receive bids from advertisers and allocate the advertisement slots, based at least in part on the received bids (e.g., based on the highest bidders at the conclusion of the auction). The bids are amounts that the advertisers are willing to pay for presentation (or selection) of their advertisement with a resource or search results page. For example, a bid can specify an amount that an advertiser is willing to pay for each 1000 impressions (i.e., presentations) of the advertisement, referred to as a CPM bid. Alternatively, the bid can specify an amount that the advertiser is willing to pay for a selection (i.e., a click-through) of the advertisement or a “conversion” following selection of the advertisement. The selected advertisements can be determined based on the bids alone, or based on the bids of each bidder being multiplied by one or more factors, such as quality scores derived from advertisement performance, landing page scores, and or other factors. In some implementations, the bids can be based on whether the ad includes social information, such as information that identifies how the user or other users in the user's social network have responded to the ad or whether the ad has been re-published. In some implementations, clicks, impressions and conversions associated with ads that are re-published to activity streams may or may not be charged.

A conversion can be said to occur when a user performs a particular action related to an advertisement provided with a resource or search results page. What constitutes a conversion may vary from case-to-case and can be determined in a variety of ways. For example, a conversion may occur when a user clicks on an advertisement, is referred to a web page, and consummates a purchase there before leaving that web page. A conversion can also be defined by an advertiser to be any measurable/observable user action, such as downloading a white paper, navigating to at least a given depth of a website, viewing at least a certain number of web pages, spending at least a predetermined amount of time on a website or web page, registering on a website, re-publishing an ad to other users within a social network, or commenting upon an ad where the comments are visible to others. Other actions that constitute a conversion can also be used.

The system 100 includes one or more social networking systems 120 that provide functions and tools for users to share information in a social network. For example, a social networking system 120 can be a social networking website that users can use to identify friends and social groups (e.g., circles), send and receive email, post messages and multi-media (e.g. photos, video, audio), track social events, provide updates and so on.

For situations in which the systems discussed here collect personal information about users, the users may be provided with an opportunity to opt in/out of programs or features that may collect personal information (e.g., information about a user's preferences or a user's current location). In addition, certain data may be anonymized in one or more ways.

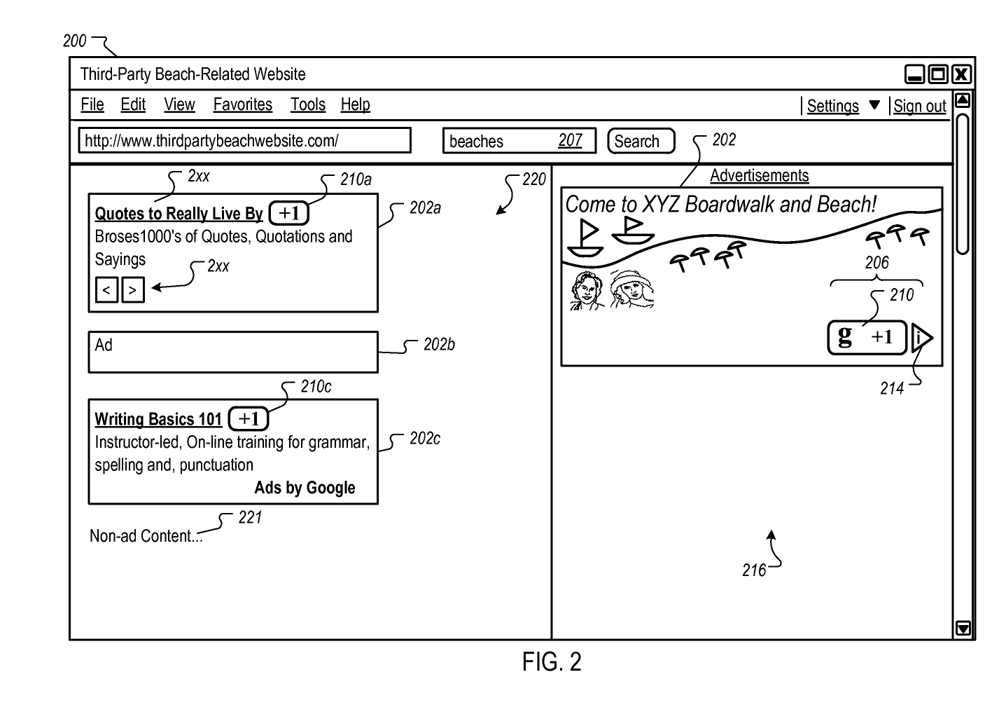

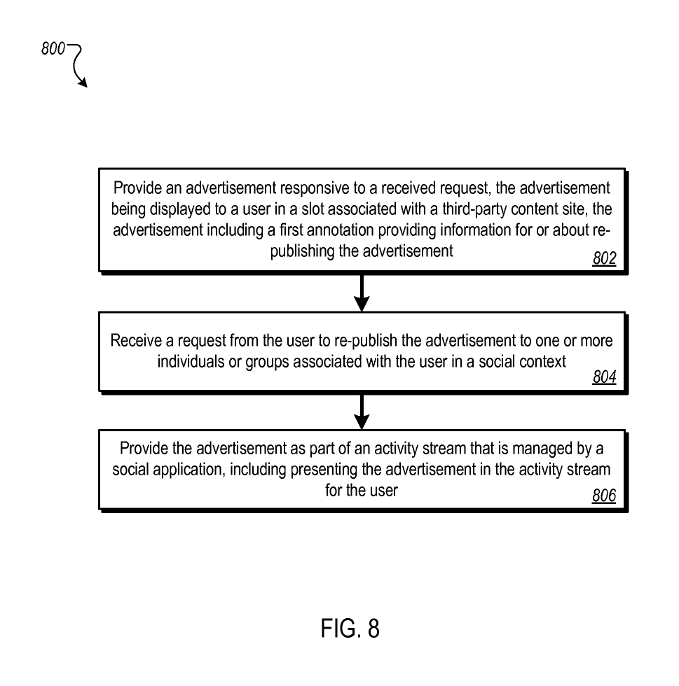

Example user interfaces for re-publishing ads to activity streams are described below with reference to FIGS. 2-7E. An example process by which ads are re-published to activity streams is described below with reference to FIG. 8. Various user interface elements for receiving user data input are described below with reference to FIGS. 2-7E. Example user interface elements include text boxes, radio buttons, check boxes, drop-down menus, and hypertext links.

FIG. 2 shows an example user interface 200 that includes content (e.g., ad) 202 with an annotation 206 that includes a control 210 for re-publishing the content (e.g., ad). For example, a user can use the control 210 to re-publish the ad to one or more members of the user's groups. The user interface 200 can be provided, for example, by the ad management system 110 of FIG. 1. For example, the ad 202 can be an ad that is served with other content, such as included with search results 118 that are responsive to a user's query 116, as described above. In another example, the ad 202 can be any ad that appears on a third-party website, such as the third-party website (e.g., related to area beaches) that is displayed in the user interface 200. For example, the third-party beach-related website can be a landing page associated with one of several search results 118 that are responsive to a search query 207 for “beaches.”

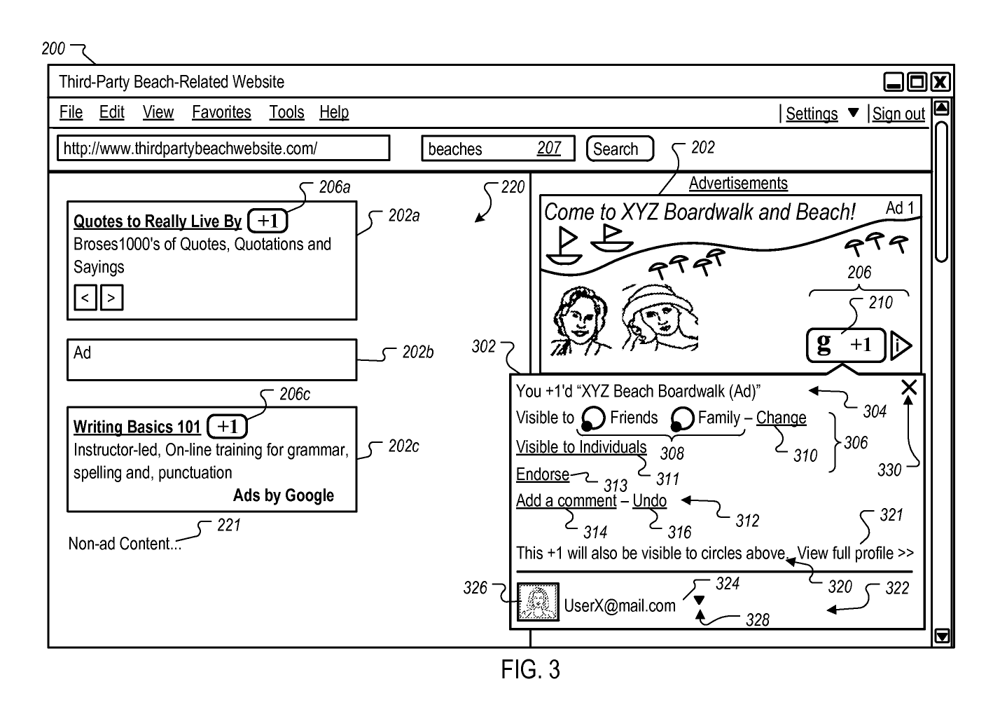

The control 210 can include and/or provide access to various controls for re-publishing and/or commenting on the ads (e.g., the ad 202). In this example, the control 210 is a plus one control for re-publishing or commenting upon the ad 202, and an information control 214. The plus one control 210 can lead to an interface from which the user can provide detailed information, as will be described below with reference to FIG. 3. By selecting the information control 214, for example, the user can navigate to a website or other information source that provides information on ads and re-publishing ads.

The ad 202 can be one of several ads that appear in an advertisements section 216 on the third-party website. For example, other ads 202a, 202b and 202c can appear in a content section 220 of the third-party website. Ads 202a and 202c can include controls 210a and 210c, respectively, that can be similar to the control 210 described above, allowing the user to re-publish the ads 202a and 202c, respectively.

FIG. 3 shows an example details popup 302 for providing detailed information for re-publishing an ad. The details popup 302 can be displayed, for example, if the user selects the plus one control 210 shown in FIG. 2. The details popup 302 is just one example implementation of an interface that the user can use to provide detailed information for re-publishing an ad (e.g., re-publishing and/or commenting upon the ad 202). A header 304 can explain why the details popup 302 is displayed. In this example, the header 304 states that the user plussed-one (or re-published) the “XYZ Beach Boardwalk” ad that is the subject of the ad 202a-c, and in this case, the name of the advertiser. In some implementations, the name of the advertiser can be determined using application code that runs behind the plus one control 210 or the details popup 302, such as at the same time that the application retrieves existing social annotations and user information. In some implementations, if the user is the first person in a social group (e.g., friends, family, etc.) to see the ad 202a-c, or if no one else has re-published or commented upon the ad 202a-c, then a message can indicate to the user that he is the first to re-publish/comment.

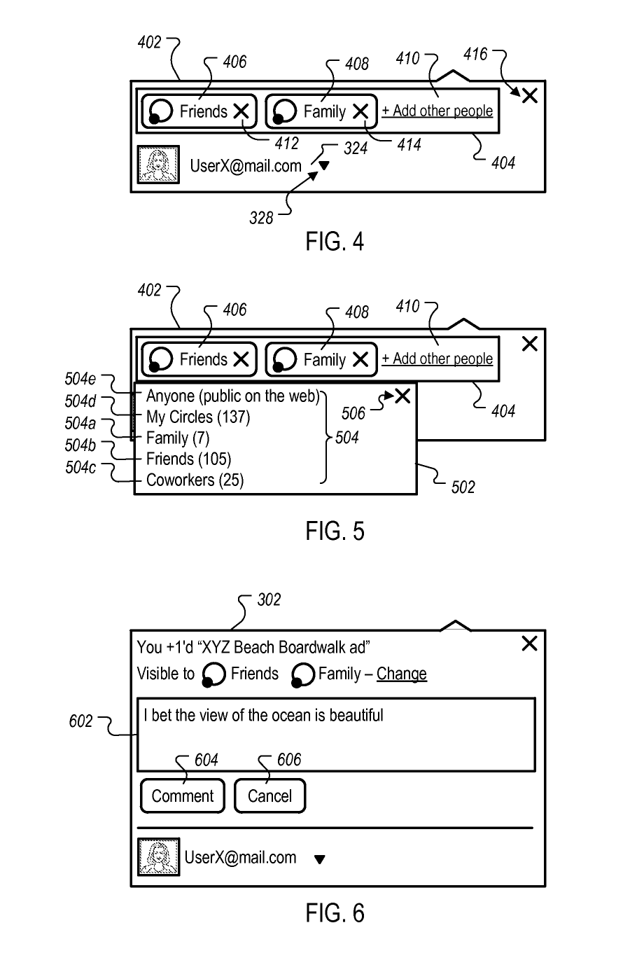

The details popup 302 includes a visibility area 306 that summarizes the groups with which the user's ad re-publishing/comments are to be applied. For example, current settings 308 indicate that the user's re-published information is to be visible to (and thus shared with) the user's friends and family. The user can use a change control 310 to change the visibility of the re-published information, effectively changing the current settings 308. FIGS. 4 and 5, described below, show example user interfaces that can appear if the user selects the change control 310.

In some implementations, the user can designate that the advertisement is to be provided to a social application for presentation in an activity stream associated with the user. The advertisement and associated comments can be displayed, for example, as part of an update posted to the user's activity stream. In some implementations, the user can designate that the advertisement is to be provided to a social application for presentation as an update for the user in an activity stream associated with one or more members of a group specified by the user. For example, the advertisement and associated comments may be presented as an update to an activity stream of each member of each group specified in the current settings 308. As another example, some or all groups specified in the current settings 308 may have an associated activity stream in a social application, and the advertisement and associated comments may be presented as an update to each of those activity streams.

In some implementations, the details popup 302 includes a visible to individuals control 311 that user can select, for example, to re-publish the ad 202a-c to specific individuals. For example, by selecting the visible to individuals control 311, a popup or other control can be displayed in which the user can select the identities of individuals with whom to re-publish the ad. In some implementations, the users selected may or may not be in any of the user's social circles of friends, family, etc. The identities of individuals that the user selects using the visible to individuals control 311 can correspond to the identities of the users on one or more social networking web sites.

The details popup 302 includes a commenting area 312 for adding a comment and/or removing a comment that has been associated with an ad. The commenting area 312 includes an add comment control 314 for adding a comment (e.g., described below with reference to FIG. 6) and an undo comment control 316 for undoing (or deleting) the added comment. In some implementations, the undo comment control 316 does not appear within the details popup 302 (or may be grayed out or otherwise inactive) until a comment has been added.

In some implementations, the details popup 302 includes an endorse control 313 control that user can select, for example, to indicate an endorsement of the ad 202. Other example endorsements can include, for example, support, back, admire, like, approve, etc. In some implementations, other controls can be included, such as an Un-endorse control (not shown in FIG. 3)

A statement 320 that can be displayed within the details popup 302 can identify, to the user, the users (e.g., individuals, specified or inferred groups or social circles) who may be eligible to see the re-published ad. For example, the statement 320 can state, “This +1 will also be visible to circles above.” As a result, the user can become acquainted with the mechanics and consequences of re-publishing ads that result from the selections and settings in the details popup 302, further allowing the user to understand the visibility of the ad-re-publishing. In some implementations, if the user has used the change control 310 to change the visibility to the extent that no other users currently have visibility, then the statement 320 can state, for example, “No users currently have visibility.” By selecting a view full profile control 321, the user can navigate, for example, to the advertiser profile page on a social network site.

In some implementations, filtering or limiting of re-publication requests can occur. As a result, the mere designation by a user to re-publish to one or more groups or individuals does not necessarily mean that re-publishing will occur. For example, the designated receivers may have blocked receipt (e.g., by setting preferences in a browser to block all or selected types of social sharing of content and/or ads).

Some implementations of the ad management system 110 may filter re-publication requests based on one or more criteria. In some implementations, filtering the request can include evaluating one or more characteristics of a user to whom the advertisement was requested to be re-published to in order to determine if the request should be granted. In some implementations, filtering can be based on criteria that include imposing limits on re-publishing, e.g., limiting the number of re-publishing events (e.g., on a user basis), the number of recipients, and so on. In some implementations, imposed limits on re-publishing can be applied to intervals of time, e.g., enforcing a limit of five re-published ads per day, twenty re-published ads per week, and so on. As a result, the ad management system 110 can prevent users from re-publishing too often or to too many people.

In some implementations, filtering the request can include evaluating one or more criteria for the advertiser associated with the advertisement that is proposed to be re-published in order to determine if the request should be granted. For example, some advertisers may impose limits or restrictions under which their ads are re-published. In some implementations, filtering the request can include evaluating historical re-publishing statistics in order to determine if the request should be granted. In some implementations, evaluating the historical re-publishing statistics includes using statistics associated with the user, such as the number of recent re-published ads to a user's activity stream. In some implementations, evaluating the historical re-publishing statistics includes using statistics associated with the advertisement, such as comparing a count of the number of re-publishing events of an ad to the maximum allowed for the ad over a certain time period. In some implementations, the number of re-publishing requests can be limited based on a per-user basis, e.g., the re-publishing quota for that user. In some implementations, the number of re-publishing requests can be limited based on the characteristics of the user or followers of a user's activity stream. For example, limitations can be based on the maximum number of re-publishing events that are allowed for one or more of the user's friends. Other criteria can be used for filtering re-publishing requests.

In some implementations, an email area 322 can identify the user account 324 (e.g., UserX@mail.com) from which the ad-re-publishing will occur. For example, the account can be associated with an email address that can be tied to the user's social networking account. Alternatively, the email address may not be tied to any social networking account. In some implementations, a user profile image 326 can provide a visual identification to the user as to what account 324 is currently displayed. If the user has multiple computer logins and/or accounts, then the user can use a change control 328, for example, to select a different one of the user's accounts (e.g., UserX@ABCDmail.com). In some implementations, ad-re-publishing need not rely upon the user having an email account. For example, the user can belong to one or more social networking systems, and ad-re-publishing that the user performs can be tied to a user name, a user account, or other form of user identification.

As a result of selecting which account (email or user login/account) to use, the user is also associating the ad-re-publishing with the groups or social circles that correspond to that user account. For example, the user's circles of family and friends may be vastly different for the social networking accounts associated with the user's email addresses UserX@mail.com versus UserX@ABCDmail.com (or one user login/account versus another user login/account).

A close control 330 can be used to exit the details popup 302 and save the current settings and inputs. In some implementations, a cancel control can exist that can allow the user to exit the details popup 302 without saving any changes, essentially restoring the values of the details popup 302 to their original settings (e.g., before the user displayed the popup).

In some implementation, the details popup 302 can include an option to un-plus the ad, or to cancel the act of re-publishing the ad with others. For example, if the user changes his mind about sharing the ad with family and friends, or decides not to share his comments, the user can select an un-plus option (not shown in FIG. 3).

FIG. 4 shows an example visibility change popup 402 for changing visibility settings for re-publishing an ad. In some implementations, the user interface 200 can display the visibility change popup 402 when, for example, the user selects the visibility change control 310 described with reference to FIG. 3. As an example, the user may select the visibility change control 310 to delete one or more of the visibility settings 308 (e.g., “Friends” or “Family”) and/or to choose additional visibility options.

In some implementations, when the visibility change popup 402 is displayed, the current visibility settings 308 can be displayed as selectable controls, e.g., controls 406 and 408 (e.g., for “Friends” and “Family”). The controls 406 and 408 can identify the name of the group for which visibility is currently set for the user's re-published ad.

An add other people control 410 can provide a way for adding additional individuals or groups to the existing groups for which visibility exists regarding the user's re-published ad. For example, if the user selects the add other people control 410, another popup can appear from which the user can add visibility entities, as described below with reference to FIG. 5.

The controls 406 and 408 can further include delete controls 412 and 414, respectively, that the user can use to selectively delete either or both groups. For example, by selecting the delete control 412, the “Friends” group can be removed from visibility, and the group control 406 can disappear from the visibility change popup 402.

In some implementations, by clicking on the either of the controls 406 and 408, the user can view the names of the users in that group. For example, if the user selects the “Friends” control 412, then the user interface 200 can display a popup that lists the people in the user's circle of friends.

In some implementations, the visibility change popup 402 can display the user account 324 and the change control 328 that the user can select to switch to a different user login. The user may switch to a different user login, for example, in order to re-publish the ad with a different circle of family and friends, e.g., the family and friends associated with his other user login (e.g., UserX@ABCDmail.com).

A close control 416 can be used to exit the visibility change popup 402 and save the current settings and inputs. In some implementations, a cancel control can exist that can allow the user to exit the visibility change popup 402 without saving any changes, essentially restoring the values of the visibility change popup 402 to their original settings (e.g., before the user displayed the popup).

FIG. 5 shows an example groups selection list 502 for displaying selectable visibility groups. For example, the user interface 200 can display the groups selection list 502 if the user selects the add other people control 410 on the visibility change popup 402 as described above.

The groups selection list 502 can include group entries 504, each of which can identify the name of the group and can further include, in parentheses, the number of people in that group. For example, the group entries 504 can include a Family group 504a with seven members, a Friends group 504b with 105 members, and a coworkers group 504c with 25 members. In some implementations, the group entries 504 can include entries that are supersets or unions of two or more other groups. For example, a My Circles group 504d can represent the union of the Family, Friends and Coworkers groups 504a-c. As a result, the total membership in the My Circles group 504d (e.g., 137) can be the sum of the group memberships that the superset group includes (e.g., 7+105+25). An Anyone group 504e can apply to the group by which the user can re-publish the ad with everyone online, and the parenthetical membership for the Anyone group 504e can be “public on the web.” In some implementations, by selecting the parenthetical membership number, the user interface 200 can display the list of individual members in the group. For example, the user may want to see the names of the people in a group as reminder of who the re-published ad would be shared with if that group is made visible.

In some implementations, each time the user selects a new group from the group entries 504, a selectable control for that group can appear in the visibility change popup 402, such as is shown for the Friends control 406 and the Family control 408. In some implementations, updating the controls in the visibility change popup 402 may not occur until after the user exits the groups selection list 502, such as by selecting an exit control 506.

FIG. 6 shows an example add comment box 602 for commenting on an ad. For example, the user can use the add comment box 602 to enter a comment associated with an ad (e.g., the ad 202). The user interface 200 can display the add comment box 602, for example, if user selects the add a comment control 314 in order to comment upon the ad 202 and share his comments with others. As an example, if the ad 202 advertises a particularly interesting-looking waterfront location (e.g., the oceanfront boardwalk in the ad 202), then the user may enter, “I bet the view of the ocean is beautiful!” or some other comment in the add comment box 602. In some implementations, as soon as the user begins typing in the add comment box 602, any prompt message (e.g., “add comment . . . ”) can be immediately replaced by whatever the user types in.

By selecting a comment control 604, the user can save the comment that he has typed into the add comment box 602, and the saved comment can be displayed, for example, in the details popup 302. However, if the user decides not to keep the comment, the user can select a cancel control 606. Comments entered using the add comment box 602 can appear in an activity stream, such as the user's activity stream that lists recent activities performed by the user. In some implementations, the activity stream that is updated with the comment can be on a social website. In some implementations, comments that are posted to one or more activity streams can be in a standardized format so that any social website can interact with the comment and other components of an activity stream.

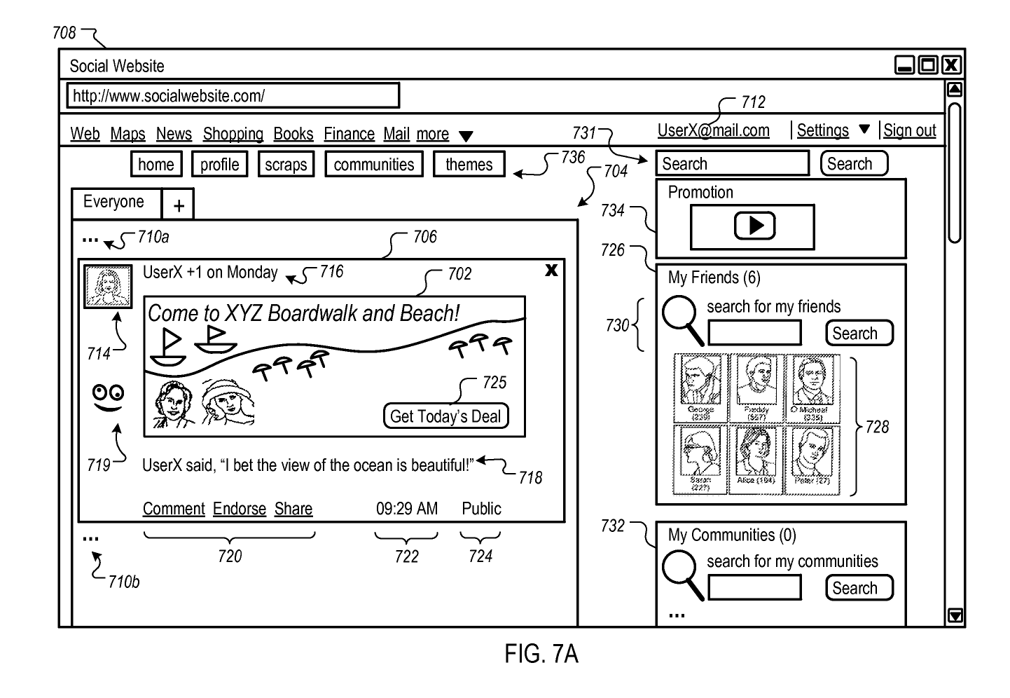

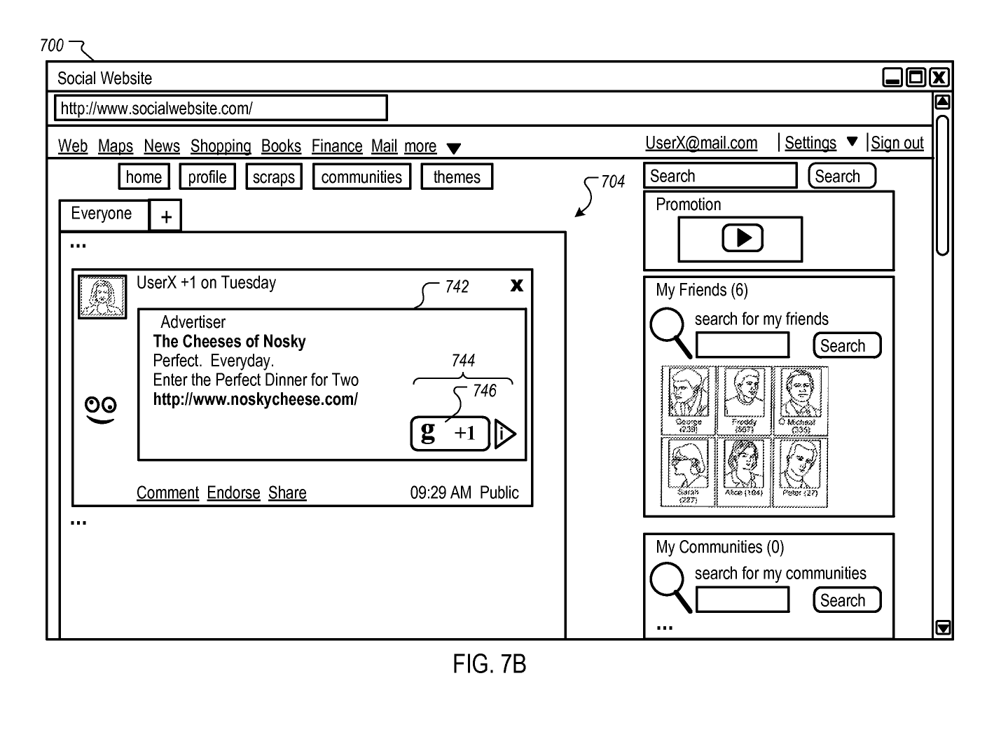

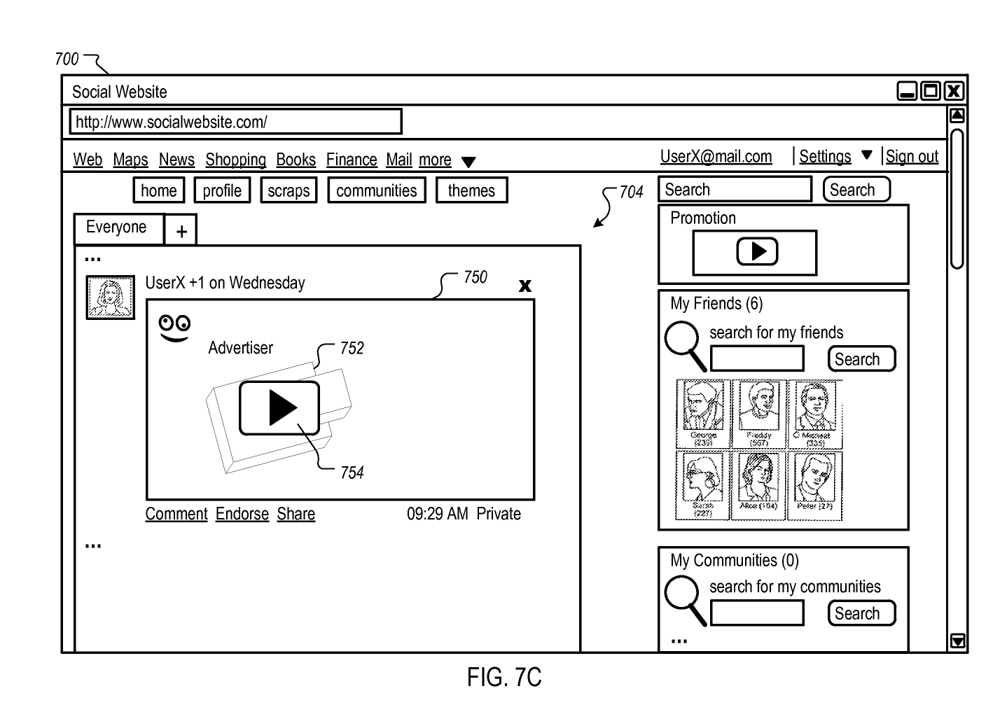

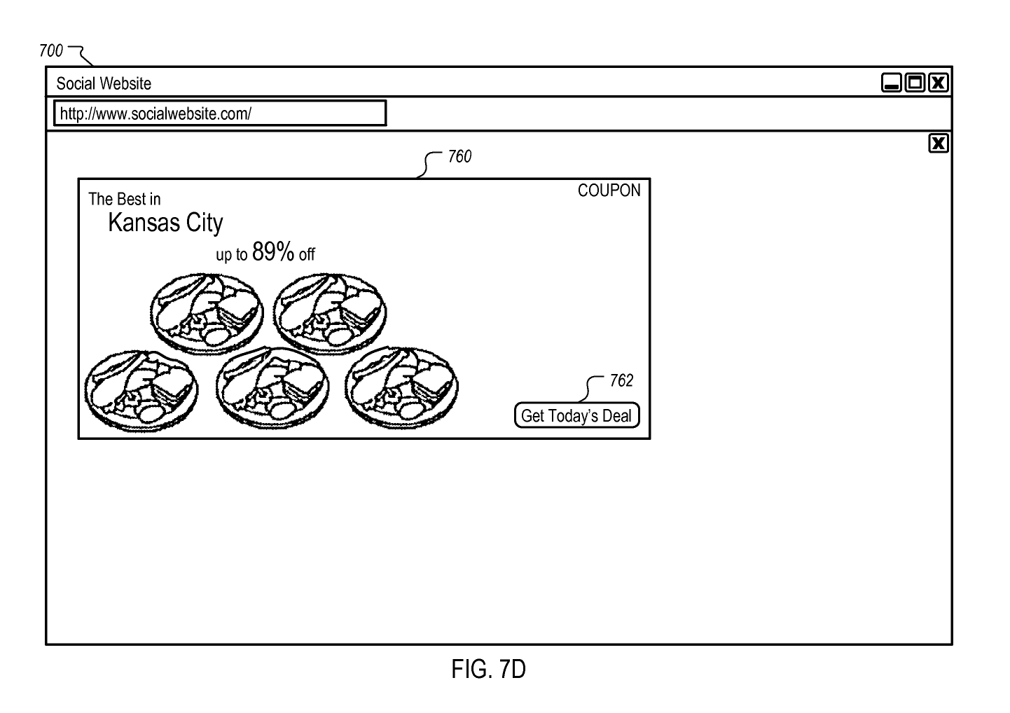

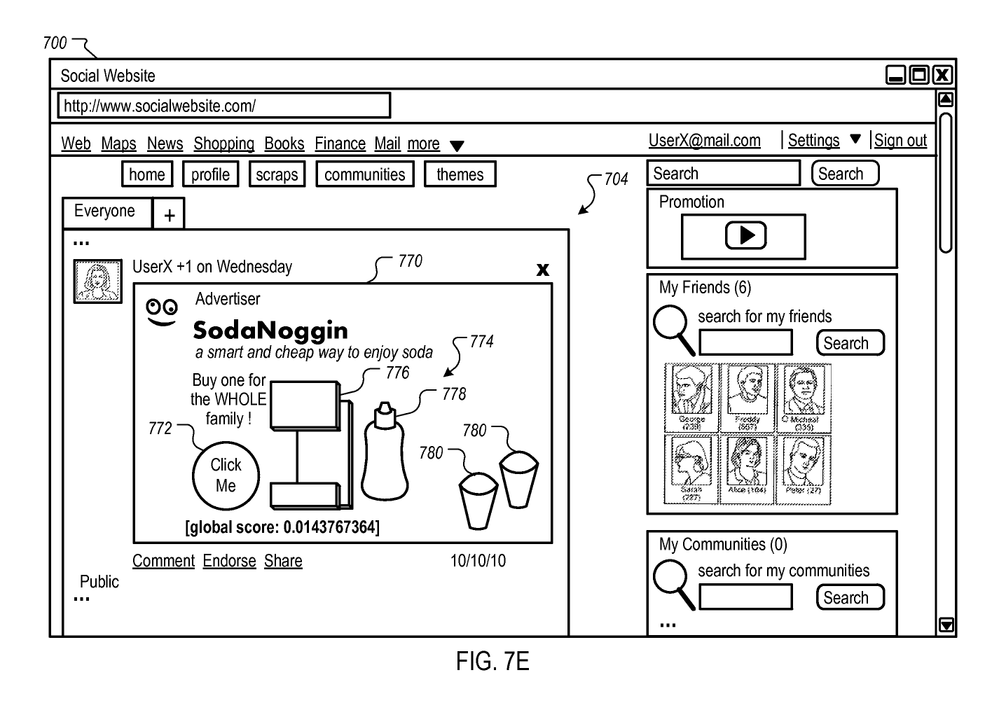

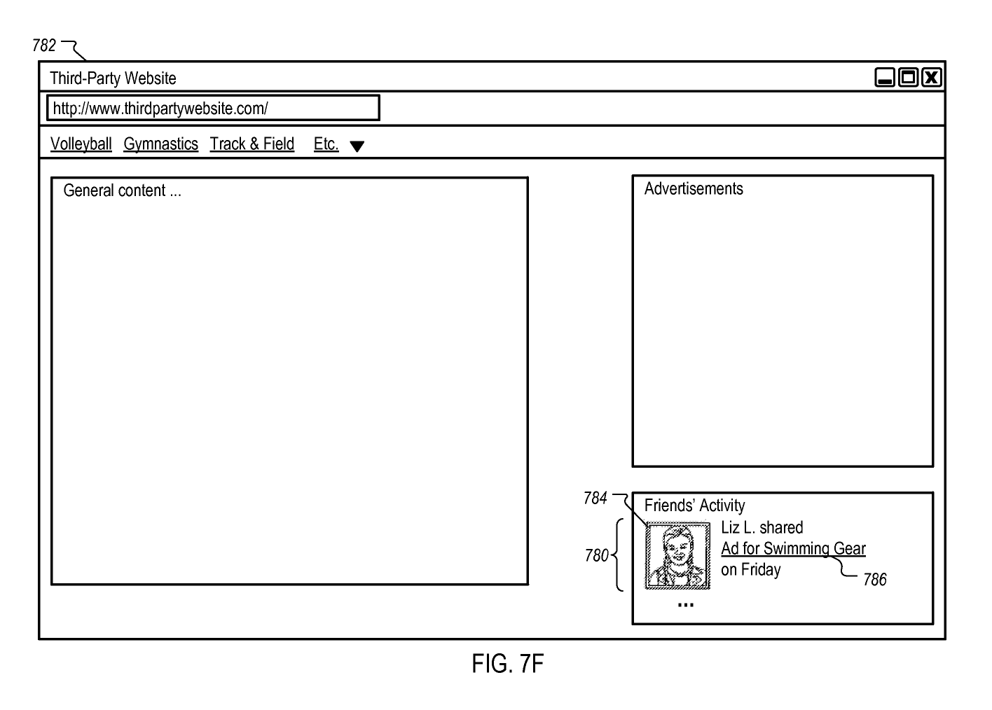

FIG. 7A shows an example display ad 702 that is re-published in an activity stream 704. The display ad 702 is just one of several types of ads (e.g., text ads, video ads, etc.) that can be re-published to an activity stream. For example, the display ad 702 is the re-published version of the “XYZ Beach Boardwalk” ad 202 that the user has re-published using the control 210, as described above with reference to FIG. 2.

In some implementations, the activity stream 704 can be displayed within a social networking application (e.g., Orkut, MySpace, Buzz), such as on the corresponding social networking web site. The display ad 702 can be included in a posting 706 that appears on a social networking web page 708. The posting 706 can be one of several postings in the activity stream 704 for the user. Ellipses 710a represent postings that appear above the posting 706 in the activity stream 704, and ellipses 710b represent postings that appear below the posting 706 in the activity stream 704. The postings that are not shown in FIG. 7A can be other postings that include re-published ads, or they may be other postings that typically appear on a social networking “wall” or home page, for example, or a mixture of various types of postings. In general, as is typical with most social networking applications, the newest posting in an activity stream appears at the top. Some implementations of social networking applications can include controls for sorting postings such as the posting 706 in various ways, including to sort and display postings that include re-published ads.

In some implementations, the user to whom the activity stream 704 belongs is identified by a user email 712 (e.g., UserX@mail.com) or some other user identifier. For example, the user email 712 can correspond to the user email account 324 that the user selected to associate with the re-published ad. The user who re-published the ad can also be identified by a thumbnail image 714. In general, a posting made by a user, including a posting that results from re-publishing an ad, can be attributed to the user by using the thumbnail image 714 and a user name or identifier. As such, the same thumbnail image 714 can appear in a similar posting within the activity stream of another user, such as one of UserX's friends who has visibility to this particular posting 706. In this way, the thumbnail image 714 can provide a visual indication of who re-published the ad.

The identity of the user who re-published the ad can appear in other places within the posting 206. For example, a posting title 716 can identify the name of the user who re-published the ad and the time that re-publishing occurred (e.g., “UserX+1 this ad on Monday”). If the user also commented on the ad (e.g., commented on the ad 202 using the add comment box 602 describe above with reference to FIG. 6), then a user comment 718 can also identify the user. For example, the user comment 718 can say, ‘UserX said, “I bet the view of the ocean is beautiful!”’

In some implementations, if the user has endorsed the ad (e.g., selected the endorse control 313), then the posting 706 can include an endorsement symbol 719. In some implementations, the social networking application can use one or more other symbols that correspond to user reactions (e.g., “un-endorsement” with a frowning face, etc.) to the original ad 202.

The posting 706 can include controls 720 by which a user who has the posting 706 displayed can perform various actions, such as commenting on the ad 702, endorsing the ad 702, or sharing (e.g., re-publishing) the ad 702 or following the advertiser. In some implementations, controls similar to the controls 720 can exist for actions that the user can take regarding the posting 706, such as commenting on, endorsing or sharing the posting 706. In some implementations, selecting controls to perform an action regarding the ad 702 and/or the posting 706 can display user interfaces that are common to the social networking application, or the user interfaces may be similar to the popups described above with reference to FIGS. 4-6, for example.

The posting 706 can include a timestamp 722 that identifies the time at which the posting 706 was created, e.g., the time at which the user re-published the ad. The posting 706 can include a visibility indicator 724 (e.g., “public”) which can indicate the visibility of the posting 706. For example, if the visibility indicator 724 is “public,” then the posting 706 is visible to the entire world. Other values of the visibility indicator 724 can include “private” (e.g., visible to the user only), “friends” (e.g., visible to the user's circle of friends), “family” (e.g., visible to the user's defined set family members), and so on. In some implementations, more than one value can be displayed for the visibility indicator 724. In some implementations, symbols can also be displayed adjacent to a value, e.g., a globe or Earth symbol displayed next to a “public” visibility indicator 724.

The particular visibility of the posting 706 (and value(s) of the visibility indicator 724) can depend, for example, on the values selected by the user on the visibility popup 402, as described above with reference to FIG. 4. Furthermore, if the user used the visible to individuals control 311 to select specific users to which to re-publish the ad, the posting 706 can include an “Individuals” control or display (not shown in FIG. 7A) that the user can use to display the particular users who can see the posting, e.g., in addition to any of the user's family, friends, etc.

While the primary component of the posting 706 is the ad 702, the elements 714-724 can serve to annotate the ad 702. For example, the elements 714-724 identify the source of the re-publishing (e.g., by identifying the user) and provide tools for further commenting and re-publishing. Furthermore, if one or more users comment upon or re-publish the ad, the annotation of the ad 702 can grow. For example, if UserY comments on the ad 702, then UserY's comment can be added to the annotation of the ad 702, such as just below UserX's user comment 718.

In some implementations, the ad 702 that is published in the activity stream 704 can include elements (e.g., text, images, etc.) that were not included in the original ad (e.g., the ad 202). As an example, when a representation of the ad 702 is rendered in the activity stream 704, the ad 702 can include a control 725 that can offer an additional enticement to the user's friend to click on or otherwise interact with (e.g., re-publish) the ad 702.

In some implementations, the posting 706 can identify the number of users in a user's group (e.g., social circles, friends, family, etc.) who endorsed the advertisement. For example, referring to FIG. 3, the user may use the endorse control 313 to indicate an endorsement of the ad 202. Further, one or more of the user's friends and family may see the re-published ad in an activity stream. As a result, the posting 706 can include a message such as, “You, Alice, Betty and three others endorsed this ad.”

In some implementations, the posting 706 can include a message that is proximity-based, such as a message about an ad that was re-published within a certain timeframe or within a certain geographic location or region. For example, the posting 706 can include a message that says, “You and twelve others in your city of Anytown re-published this ad.”

A friends area 726 can identify the user's current set of friends. For example, a thumbnail display 728 can include small images and the names of each of the user's friends. In some implementations, search controls 730 can allow the user to search for one or mare particular users by typing in a search string and selecting a control. Similarly, search controls 731 can allow the user to search for specific text on the social networking web page. For example, a user can search for “advertiser” to find re-published ads. A communities area 732 can be similar to the friends area 726, but can identify communities that the user has selected to be part of his social networking profile.

In some implementations, the example social networking web page 706 includes a promotion control 734, for example, that plays a multimedia ad that can include animation, video, and interactivity (e.g., using Flash or other multimedia software). In some implementations, the example social networking web page 706 includes options 736 that the user can use, for example, to navigate to a “home” page showing the user's current activity, user profile information, and so on.

Some of the information that appears in the user's activity stream 704 also appears in the activity stream of others. For example, UserY, who may be a friend of UserX, can see any of the postings 706 to which UserX has provided visibility. For example, UserX may generally grant all of his family and friends access to his postings. Furthermore, when sharing an ad such as the ad 202 described with reference to FIG. 2, the user UserX may use the visibility popup 402 grant visibility to friends and family, including User Y.

Because ads can have different formats (e.g., text, images, video, flash, etc.) and sizes, some ads that are re-published in an activity stream are not rendered in their original format. For example, dynamic content, such as flash or video ads, may not be supported by the application that generates the activity stream. Furthermore, ads that include very large images may also not be supported in their original format. In some implementations, larger image ads that are re-published may be rendered as a thumbnail or other compressed version of the original image. In some implementations, image ads may be represented in the activity stream by the original image only if they are small enough. In some implementations, dynamic ads can be represented by a generic image that indicates the nature of the content.

In some implementations, when a user clicks on the ad representation for a re-published ad in the activity stream, the system can either display the original ad as an overlay on top of the activity stream or expand the ad representation by rendering the original ad. For dynamic ads, the overlay or the in-place expansion can support the original content. In some implementations, clicking on the overlay or the in-place expansion can navigate the user to the landing page that is associated with the ad.

FIG. 7B shows an example text ad 742 that is re-published in the activity stream 704. In some implementations, the re-published ad 742 includes an annotation 744 that includes a control 746. In some implementations, the annotation 744 can operate in the same way as the annotation 206 that is described above with reference to FIGS. 2-6. For example, by selecting the control 746, the user can re-publish the ad 742 to his activity stream. In some implementations, when the ad 742 is re-published, it can include some of the social information from the ad 742. For example, if UserY re-published the ad 742, annotations on the re-published ad that appears in UserY's activity stream can include information about UserX's original re-publishing. In some implementations, by re-publishing an ad using the control 746, a new thread can be started, e.g., excluding any mention of UserX.

FIG. 7C shows an example multimedia ad 750 that is re-published in the activity stream 704. The ad 750 can be considered a multimedia ad, for example, if it includes animation, video, and interactivity (e.g., that can be rendered using Flash or other multimedia software). The ad 750 can also include text, images, or other features.

The multimedia ad 750 that is shown includes an object image 752. For example, the object 752 can be an image that represents the subject of the ad. Overlaid over the image is a control 754 that the user can select, for example, to begin interacting with ad 750, or to start the corresponding video or animation. As a result of selecting the control 754, meta-data associated with the ad 750, including URLs, can be accessed. For example, the URL may be used to access the underlying code that “plays” the video or animation. As a result of selecting the control, the resulting animation or video can be displayed as an overlay on the user's activity stream, such as the activity stream 704. In some implementations, other controls in addition to the control 754 can be included in the ad 750. For example, other controls may allow the user to fast-forward through a video, to stop or pause the video, to interact in other ways with the ad 750, or to exit the ad 750 completely (e.g., returning focus to the activity stream 704).

FIG. 7D shows an example re-published display ad 760 that is expanded. In this example, the user may have clicked on the representation of the ad 760 that appeared in the activity stream 704. As a result, the ad can expand to a larger size than the size of the ad representation that is included in the activity stream 704. In some implementations, by expanding an ad, the URL or other meta-data associated with the ad can be used to enhance the ad in some way. For example, the URL can be used to access and obtain a higher-resolution image of the ad in order to display a higher resolution than the thumbnail version that may appear in the activity stream. Other example enhancements include adding features of the ad that were omitted in the representation published in the activity stream, such as a daily specials control 762 or other additional text or images. As a result, by expanding the ad in this way, the user who sees and expands the ad 760 can experience the ad in essentially the same way as it was originally served (e.g., as an ad 202).

FIG. 7E shows an example multimedia ad 770 that is re-published, expanded and being played in the activity stream 704. As an example, the ad 770 can include a control 772 that can start an animation 774 (e.g., using Flash or other multimedia software). The animation 774, for example, can show a step-by-step process of using a soda-making machine 776, adding ingredients from an additive bottle 778, and creating servings of soda in soda cups 780. This is just one example of multimedia ads that can be re-published to an activity stream (e.g., the activity stream 704), expanded and played.

FIG. 7F shows an example social context entry 780 that appears on a third-party website 782. For example, the entry 780 includes an image 784 that identifies the person who shared the information. In this example, someone named “Liz” shared an ad for swimming gear, to which an ad link 786 exists that the user can select to view the ad. In some implementations, the social context entry 780 can correspond to a re-published ad that appears on an activity stream of the user's friend (e.g., Liz). Another condition of displaying the social context entry 780 can be the situation in which the subject of the ad (e.g., swimming gear) corresponds to the subject of the third-party website (e.g., sports).

Some implementations of the screens and user interfaces shown in FIG. 7A through 7F can be adapted for mobile devices. For example, the format of ads and the activity streams in which they are re-published can be changed to fit the viewport of a smartphone or other mobile device or to meet other limitations common to mobile devices.

FIG. 8 is a flowchart of an example process 800 for providing re-publishing content (e.g., an ad) that is provided by a content publisher to a user's activity stream. For example, the process 800 can be used to re-publish the ad 202 using the control 210. The process 800 can be performed, for example, by the ad management system 110.

An advertisement is provided that is responsive to a received request (802). The advertisement is displayed to a user in a slot associated with a third-party content site. The advertisement includes a first annotation providing information for or about re-publishing the advertisement. For example, referring to FIG. 1, the ad management system 110 can receive a request to provide an ad in a slot in the third-party web page that corresponds to a resource 105. The request can occur, for example, when search results 118 are generated in response to a query 116. In some implementations, the ad management system 110 can have no control of the general content of the third-party website except for providing ads that fill slots on the web page. In response to the request, the ad management system 110 can provide the ad 202 with an annotation 206 that includes a control 210 for re-publishing the ad 202.

A request is received from the user to re-publish the advertisement to one or more individuals or groups associated with the user in a social context (804). As an example, the user may select the control 210 to re-publish the ad to his activity stream. As a result, the user can then use various other subsequent controls and popups to designate the other users who can see the ad (e.g., using visibility settings) and make comments upon the ad, as described above with reference to FIGS. 2-6.

The advertisement is provided as part of an activity stream that is managed by a social application, including presenting the advertisement in the activity stream for the user (806). For example, referring to FIG. 7A, the ad 202 can appear in the user's activity stream 704 as the ad 702. The user's activity stream 704 can be displayed by a networking application that provides access to the user through a social networking web site.

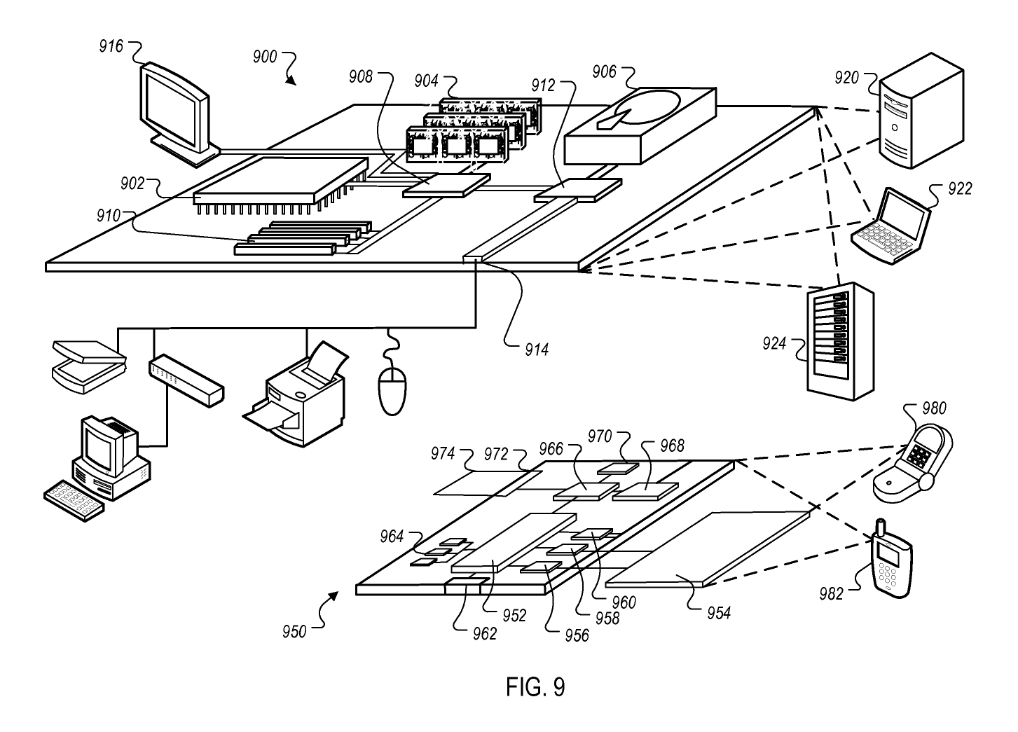

FIG. 9 is a block diagram of computing devices 900, 950 that may be used to implement the systems and methods described in this document, as either a client or as a server or plurality of servers. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a computer-readable medium. In one implementation, the memory 904 is a volatile memory unit or units. In another implementation, the memory 904 is a non-volatile memory unit or units.

The storage device 906 is capable of providing mass storage for the computing device 900. In one implementation, the storage device 906 is a computer-readable medium. In various different implementations, the storage device 906 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of duties is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can process instructions for execution within the computing device 950, including instructions stored in the memory 964. The processor may also include separate analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD display or an OLED display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication (e.g., via a docking procedure) or for wireless communication (e.g., via Bluetooth or other such technologies).

The memory 964 stores information within the computing device 950. In one implementation, the memory 964 is a computer-readable medium. In one implementation, the memory 964 is a volatile memory unit or units. In another implementation, the memory 964 is a non-volatile memory unit or units. Expansion memory 974 may also be provided and connected to device 950 through expansion interface 972, which may include, for example, a SIMM card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS receiver module 970 may provide additional wireless data to device 950, which may be used as appropriate by applications running on device 950.

Device 950 may also communication audibly using audio codec 960, which may receive spoken information from a user and convert it to usable digital information. Audio codex 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for re-publishing content that is provided by a content publisher to a user, the method comprising:
providing an advertisement for display to a user in a slot, the advertisement including a first annotation providing information for or about re-publishing the advertisement;
receiving a request to re-publish the advertisement to one or more individuals or groups associated with the user in a social context; and
providing the advertisement as part of an activity stream for a social application, including presenting the advertisement in the activity stream for the user.

2. The method of claim 1 where providing the advertisement as part of the activity stream includes determining information to be included in a second annotation that is provided along with the advertisement when displayed in the activity stream including determining message content to be included in the second annotation.

3. The method of claim 2 where the message content includes an indicator of a number of users in a user's group that endorsed the advertisement.

4. The method of claim 3 where the user's group includes members from the user's social graph.

5. The method of claim 3 where the message content includes an indicator of which members of a user's group endorsed the advertisement.

6. The method of claim 2 where providing the advertisement includes providing either the first or the second annotation as an overlay to the advertisement.

7. The method of claim 1 where the first annotation includes an information portion and a control, the control for enabling the user to re-publish the advertisement.

8. The method of claim 7 where the control enables a user to re-publish the advertisement to one or more members of the user's groups.

9. The method of claim 8 where the groups are selected from the groups comprising a social circle, family, friends, work groups, or other particularly identified groups.

10. The method of claim 7 where the control enables the user to re-publish the advertisement to others that are not members of a user's groups.

11. The method of claim 7 where the control enables a user to re-publish the advertisement along with a message.

12. The method of claim 11 where the message is provided by the user.

13. The method of claim 11 where the message indicates that the advertisement has been re-published by the user.

14. The method of claim 11 where the message indicates that the user and a number of other users have re-published the advertisement.

15. The method of claim 14 where the other users are within a predetermined proximity of the user.

16. The method of claim 11 where the message includes two portions, a first portion that indicates who has re-published the advertisement and a second portion with specific comments by users that re-published the advertisement.

17. The method of claim 16 further comprising receiving a comment from the user to be published in the second portion.

18. The method of claim 17 further comprising providing the annotation along with the comment when re-publishing the advertisement.

19. The method of claim 1 further comprising receiving a request to re-publish the advertisement to one or more other users and re-publishing the advertisement to the one or more other users including providing a second different annotation along with the re-published advertisement.

20. The method of claim 19 where re-publishing the advertisement includes determining a message for inclusion in the second different annotation.

21. The method of claim 20 where the message includes an indication that the user has re-published the advertisement and including any comment provided by the user.

22. The method of claim 1 where providing the advertisement as part of an activity stream further includes providing visibility of the advertisement, within the social application, to the one or more individuals or groups associated with the user to whom the user re-publishes the advertisement, and further includes providing interaction with the advertisement by the user and the one or more individuals or groups associated with the user.

23. The method of claim 1 where after receiving a request to re-publish the advertisement filtering the request in accordance with one or more criteria.

24. The method of claim 23 where filtering the request includes evaluating one or more characteristics associated with the user to determine if the request should be granted.

25. The method of claim 23 where filtering the request includes evaluating one or more characteristics of a user to whom the advertisement was requested to be re-published to in order to determine if the request should be granted.

26. The method of claim 23 where filtering the request includes evaluating one or more criteria for the advertiser associated with the advertisement that is proposed to be re-published in order to determine if the request should be granted.

27. The method of claim 23 where filtering the request includes evaluating historical re-publishing statistics in order to determine if the request should be granted.

28. The method of claim 27 where the historical re-publishing statistics include statistics associated with the user.

29. The method of claim 27 where the historical re-publishing statistics include statistics associated with the advertisement.

30. The method of claim 27 where filtering the request includes re-publishing a limited number of requests in a time period.

31. The method of claim 30 where the limited number is determined on a per user basis.

32. The method of claim 30 where the limited number is determined based on characteristics of the user or followers of a user's activity stream.

33. The method of claim 1 where receiving a request from the user to re-publish the advertisement includes an identification of specific members from the user's social graph with whom the advertisement is to be re-published.

34. The method of claim 1 further comprising suggesting specific members from the user's social graph with whom the advertisement is to be re-published.

35. A method for re-publishing content that is provided by a content publisher to a user, the method comprising:
providing an advertisement for display to a user in a slot, the advertisement including a first annotation providing information for or about re-publishing the advertisement;
receiving a request from the user to re-publish the advertisement to one or more individuals or groups designated by the user; and
providing the advertisement as part of an update posting for the user in a social context, where the social context is related to a social application executing on one or more servers, the social application including a presence associated with the user for providing updates about the user to one or more subscribers.

36. The method of claim 35 where the update posting includes update content for or about the user.

37. The method of claim 36 where after receiving a request to re-publish the advertisement filtering the request in accordance with one or more criteria.

38. The method of claim 37 where filtering the request includes evaluating one or more characteristics associated with the user to determine if the request should be granted.

39. The method of claim 37 where filtering the request includes evaluating one or more characteristics of a user to whom the advertisement was requested to be re-published to in order to determine if the request should be granted.

40. The method of claim 37 where filtering the request includes evaluating one or more criteria for the advertiser associated with the advertisement that is proposed to be re-published in order to determine if the request should be granted.

41. The method of claim 37 where filtering the request includes evaluating historical re-publishing statistics in order to determine if the request should be granted.

42. The method of claim 41 where the historical re-publishing statistics include statistics associated with the user.

43. The method of claim 41 where the historical re-publishing statistics include statistics associated with the advertisement.

44. The method of claim 41 where filtering the request includes re-publishing a limited number of requests in a time period.

45. The method of claim 44 where the limited number is determined on a per user basis.

46. The method of claim 44 where the limited number is determined based on characteristics of the user or followers of a user's activity stream.

47. A computer program product embodied in a tangible medium including instructions that when executed by a processor cause the processor to:
provide an advertisement for display to a user in a slot, the advertisement including a first annotation providing information for or about re-publishing the advertisement;
receive a request to re-publish the advertisement to one or more individuals or groups associated with the user in a social context; and
provide the advertisement as part of an activity stream for a social application, including presenting the advertisement in the activity stream for the user.

48. The computer program product of claim 47 where providing the advertisement as part of the activity stream includes determining information to be included in a second annotation that is provided along with the advertisement when displayed in the activity stream including determining message content to be included in the second annotation.

49. The computer program product of claim 48 where the message content includes an indicator of a number of users in a user's group that endorsed the advertisement.

50. The computer program product of claim 49 where the user's group includes members from the user's social graph.

51. The computer program product of claim 49 where the message content includes an indicator of which members of a user's group endorsed the advertisement.

52. The computer program product of claim 48 where providing the advertisement includes providing either the first or the second annotation as an overlay to the advertisement.

53. The computer program product of claim 47 where the first annotation includes an information portion and a control, the control for enabling the user to re-publish the advertisement.

54. The computer program product of claim 53 where the control enables a user to re-publish the advertisement to one or more members of the user's groups.

55. The computer program product of claim 54 where the groups are selected from the groups comprising a social circle, family, friends, work groups, or other particularly identified groups.

56. The computer program product of claim 53 where the control enables the user to re-publish the advertisement to others that are not members of a user's groups.

57. The computer program product of claim 53 where the control enables a user to re-publish the advertisement along with a message.

58. A system comprising:
an advertising management system that provides an advertisement for display to a user in a slot, the advertisement including a first annotation providing information for or about re-publishing the advertisement; and
a social networking application that receives a request from the user to re-publish the advertisement to one or more individuals or groups associated with the user in a social context and provides the advertisement as part of an activity stream that is managed by the social networking application, including presenting the advertisement in the activity stream for the user.
